(19) United States
(12) Patent Application Publication
(10) Pub. No.: US 2021/0343253 A1
(43) Pub. Date: Nov. 4, 2021

(54) DISPLAY DEVICE

(71) Applicant: SHARP KABUSHIKI KAISHA, Sakai City, Osaka (JP)

(72) Inventors: NAOKO GOTO, Sakai City, Osaka (JP); AYA OKAMOTO, Sakai City, Osaka (JP)

(21) Appl. No.: 17/272,648

(22) PCT Filed: Aug. 8, 2019
(86) PCT No.: PCT/JP2019/031426

§ 371 Date: Mar. 1, 2021

(30) Foreign Application Priority Data
Sep. 3, 2018 (JP) 2018-164691

(51) Int. Cl. G09G 3/34

(52) U.S. Cl. CPC G09G 3/3426; G09G 2360/16

(57) ABSTRACT

A display device includes: an area-active drive circuit, a backlight divided into a plurality of drive areas that undergo area-active drive by the area-active drive circuit, and a display panel. The plurality of drive areas belong to any of a plurality of calculation groups. The area-active drive circuit includes an emission-intensity calculating circuit configured to calculate, based on input image data, an emission intensity of each of the plurality of drive areas in each of frame periods, each of the plurality of drive areas belonging to one of the plurality of different calculation groups, each of the frame periods being a cycle of image update in the display panel.

### TECHNICAL FIELD

The present disclosure relates to a display device that includes a display panel and a backlight. The present application claims priority to Japanese Patent Application No. 2018-164691, filed on Sep. 3, 2018, the disclosures of which are incorporated herein.

### BACKGROUND ART

Controlling an area-active backlight using light-emitting elements, such as light-emitting diodes (LEDs), enables backlight control in local areas. Local dimming (also called area activation) is proposed in a display device that performs such backlight control. Local dimming offers intrinsic brightness levels of pixels by calculating a backlight brightness level corresponding to an image that is input to the pixels of a display panel, and dividing the brightness of the pixels by the backlight brightness. Patent Literature 1 discloses an example of such a technique.

### CITATION LIST

### Patent Literature

Patent Literature 1: Japanese Patent Application Laid-Open No. 2009-192963 (published on Aug. 27, 2009)

### SUMMARY OF INVENTION

### Technical Problem

The aforementioned local dimming includes calculating backlight brightness in each area consisting of one or more light-emitting elements. More areas are recently required in response to an increase in the number of pixels in the display panel and a demand for stricter backlight control. This unfortunately increases calculation volume in local dimming.

To solve this problem, it is an object of one aspect of the present disclosure to provide a display device that reduces the volume of calculation in a local-dimming processing circuit (area-active drive circuit).

### Solution to Problem

To solve the above problem, a display device according to one aspect of the present disclosure includes the following: an area-active drive circuit; a backlight divided into a plurality of drive areas that undergo area-active drive by the area-active drive circuit; and a display panel. The plurality of drive areas belong to any of a plurality of calculation groups. The area-active drive circuit includes an emission-intensity calculating circuit that calculates, based on input image data, an emission intensity of each of the plurality of drive areas in each of frame periods. Each of the plurality of drive areas belongs to one of the plurality of different calculation groups. Each of the frame periods is a cycle of image update in the display panel.

To solve the above problem, a display device according to one aspect of the present disclosure includes the following: an area-active drive circuit; a backlight divided into a plurality of drive areas that undergo area-active drive by the area-active drive circuit; an emission-intensity calculating circuit that calculates, based on input image data, an emission intensity of each of the plurality of drive areas; and a display panel. The emission-intensity calculating circuit calculates the emission intensities of all the plurality of drive areas in a plurality of divided frame periods, with a cycle of image update in the display panel being defined as one frame period.

### Advantageous Effect of Invention

A display device is achieved that reduces the volume of calculation in a local-dimming processing circuit (area-active drive circuit).

### BRIEF DESCRIPTION OF DRAWINGS

FIG. 1 schematically illustrates the configuration of a backlight included in a display device according to a first embodiment.

FIGS. 2(a) and (b) illustrate an example where an emission-intensity calculator, included in an area-active drive unit of the display device according to the first embodiment, calculates the emission intensity of each drive area in one of different calculation groups in each frame period.

FIG. 3 schematically illustrates the configuration of the display device according to the first embodiment.

FIG. 4 illustrates another example where the emission-intensity calculator, included in the area-active drive unit of the display device according to the first embodiment, calculates the emission intensity of each drive area in one of the different calculation groups in each frame period.

FIG. 5(a) schematically illustrates the configuration of a backlight included in a display device according to a second embodiment. FIG. 5(b) illustrates an example where an emission-intensity calculator, included in an area-active drive unit of the display device according to the second embodiment, calculates the emission intensities of drive areas in one of different calculation groups in each frame period.

FIG. 6(a) schematically illustrates the configuration of another backlight included in the display device according to the second embodiment. FIG. 6(b) illustrates an example where the emission-intensity calculator, included in the area-active drive unit of the display device according to the second embodiment, calculates the emission intensities of drive areas in one of different calculation groups in each frame period.

FIG. 7(a) schematically illustrates the configuration of further another backlight included in the display device according to the second embodiment. FIG. 7(b) illustrates an example where the emission-intensity calculator, included in the area-active drive unit of the display device according to the second embodiment, calculates the emission intensities of drive areas in one of different calculation groups in each frame period.

FIG. 8 illustrates an example of the order of selecting one of different calculation groups in each frame period, in the emission-intensity calculator included in the area-active drive unit of the display device shown in FIG. 7 according to the second embodiment.

FIG. 9 schematically illustrates the configuration of a backlight included in a display device according to a third embodiment.

FIG. 10 schematically illustrates the configuration of a backlight included in a display device according to a fourth embodiment.

FIG. 11 schematically illustrates the configuration of another backlight included in the display device according to the fourth embodiment.

FIG. 12 schematically illustrates the configuration of a backlight included in a display device according to a fifth embodiment.

FIG. 13 schematically illustrates the configuration of the display device according to the fifth embodiment.

### DESCRIPTION OF EMBODIMENTS

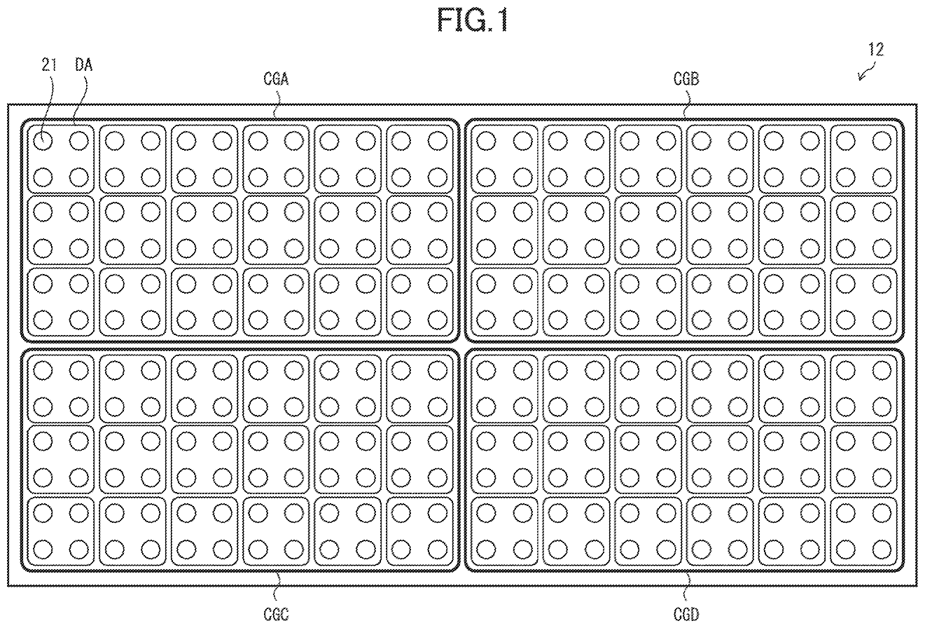

Embodiments of the present disclosure will be described with reference to FIGS. 1 to 13. For convenience in description, components having the same functions as those described in a particular embodiment will be denoted by the same signs and will not be elaborated upon.

### First Embodiment

With reference to FIGS. 1 to 4, the following describes a display device 10 according to a first embodiment.

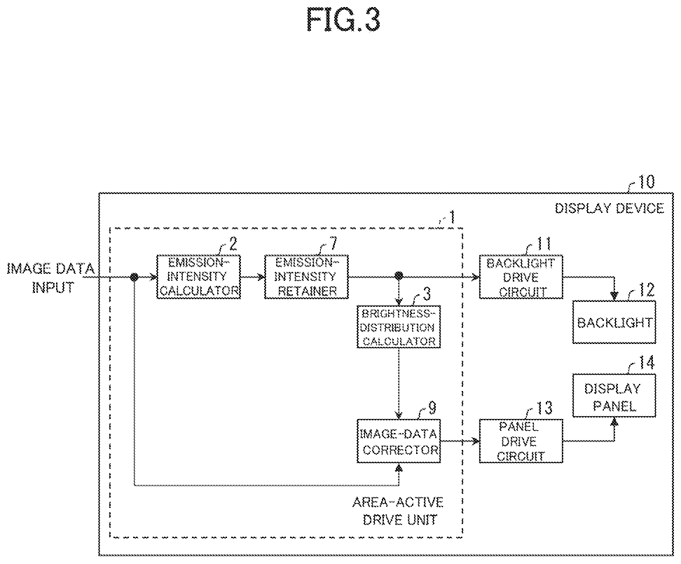

FIG. 1 schematically illustrates the configuration of a backlight 12 included in the display device 10 shown in FIG. 3.

This embodiment describes an instance where the backlight 12 includes 24×12 light-emitting elements 21; it goes without saying that the backlight 12 may include any necessary number of light-emitting elements 21. This holds true for the other embodiments.

The backlight 12 is divided into a plurality of drive areas DA (in this embodiment, 72 drive areas DA), each of which individually undergoes area-active drive. Each drive area DA, which is individually driven, is also called a light source.

Although this embodiment describes an instance where each drive area DA includes 2×2 light-emitting elements 21 adjacent to each other, each drive area DA may include any number of light-emitting elements 21; for instance, each drive area DA may include only one light-emitting element or a plurality of light-emitting elements. It is noted that the drive areas DA in this embodiment each include the same number of light-emitting elements 21. It is also noted that a plurality of light-emitting elements 21 included in the same drive area DA emit light of the same emission intensity. In this case, a point spread function (PSF), a profile of light emitted by the drive area DA, is the same in all the drive areas DA.

The light-emitting elements 21 need to emit white light, and may be, for instance, a plurality of packaged light-emitting elements that emit different colors of light, thus emitting white light.

FIG. 1 illustrates that 18 drive areas DA in the upper-left part belong to a calculation group A (CGA); 18 drive areas DA in the upper-right part, to a calculation group B (CGB); 18 drive areas DA in the lower-left part, to a calculation group C (CGC); and 18 drive areas DA in the lower-right part, to a calculation group D (CGD). Each of the calculation groups A (CGA) to D (CGD) is a group that includes the drive areas DA whose emission intensities are calculated simultaneously in one certain frame period.

FIG. 3 schematically illustrates the configuration of the display device 10 according to the first embodiment.

The display device 10 includes an area-active drive unit (area-active drive circuit) 1, a backlight drive circuit 11, the backlight 12, a panel drive circuit 13, and a display panel 14. The area-active drive unit 1 includes an emission-intensity calculator (emission-intensity calculating circuit) 2, an emission-intensity retainer 7, a brightness-distribution calculator (brightness-distribution calculating circuit) 3, and an image-data corrector (image-data correcting circuit) 9.

Based on input image data, the emission-intensity calculator 2 calculates the emission intensity of each drive area DA belonging to one of the different calculation groups A (CGA) to D (CGD) in each frame period, which is a cycle of image update in the display panel 14. That is, the emission-intensity calculator 2 calculates the emission intensities of all the drive areas DA in a plurality of divided frame periods, each of which is a cycle of image update in the display panel 14 being defined as one frame period.

The emission-intensity retainer 7 retains data about the emission intensity of each drive area DA calculated in the past. For instance, the emission-intensity retainer 7 outputs, to the backlight drive circuit 11 and the brightness-distribution calculator 3, the emission intensity data of the 18 drive areas DA in the upper-left part, which belong to the calculation group A (CGA), calculated anew by the emission-intensity calculator 2, and the currently retaining emission intensity data of the 18 drive areas DA in the upper-right part, the 18 drive areas DA in the lower-left and the 18 drive areas DA in the lower-right part, which respectively belong to the calculation groups B (CGB), C (CGC) and D (CGD). The backlight drive circuit 11 drives the backlight 12 for each drive area DA on the basis of the emission intensity data of the drive area DA.

The brightness-distribution calculator 3 calculates, for each pixel of the display panel 14, the sum total of light (backlight intensity) reaching the pixel from the drive areas DA. This calculation uses a point spread function (PSF), which is a profile of light emitted by the drive area DA. The brightness-distribution calculator 3 outputs the calculated backlight intensity to the image-data corrector 9.

The image-data corrector 9 corrects the gradation value of each pixel of the input image data on the basis of the input image data and the backlight intensity, and outputs the corrected gradation value to the panel drive circuit 13. The panel drive circuit 13 drives the display panel 14 on the basis of the corrected gradation value. The display panel 14 is a liquid-crystal panel for instance.

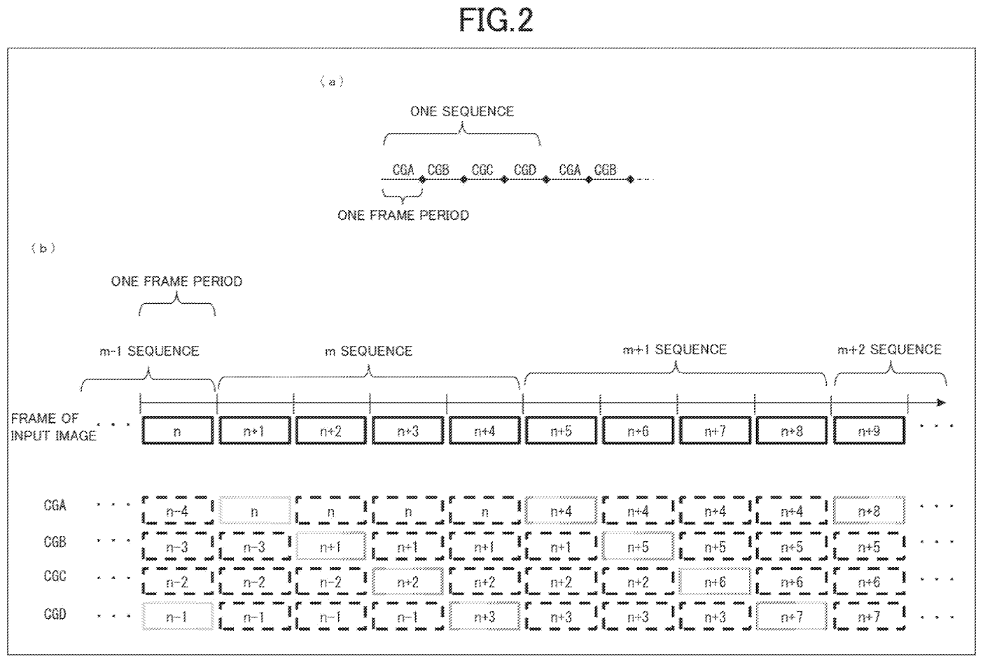

FIGS. 2(a) and (b) illustrate an example where the emission-intensity calculator 2, included in the area-active drive unit 1 of the display device 10 shown in FIG. 3, calculates the emission intensity of each drive area in one of the different calculation groups in each frame period.

As illustrated in FIG. 2(a), the 18 drive areas DA in the upper-left part, belonging to the calculation group A (CGA), simultaneously undergo emission-intensity calculation in a first frame period; moreover, the 18 drive areas DA in the upper-right part, belonging to the calculation group B (CGB), simultaneously undergo emission-intensity calculation in a second frame period; moreover, the 18 drive areas DA in the lower-left part, belonging to the calculation group C (CGC), simultaneously undergo emission-intensity calculation in a third frame period; moreover, the 18 drive areas DA in the lower-right part, belonging to the calculation group D (CGD), simultaneously undergo emission-intensity calculation in a fourth frame period. The first to fourth frame periods constitute one sequence, which is repeated.

Each of the calculation groups A (CGA) to D (CGD) is a group of drive areas DA that is calculated in one frame period by a single emission-intensity calculator 2 included in the display device 10 shown in FIG. 3; There are as many groups as divided times. Although this embodiment describes a non-limiting example where there are four divided times, thus offering the four calculation groups A (CGA) to D (CGD), two or more calculation groups need to be provided.

FIG. 2(b) illustrates the relationship between frames that are input to the display device 10, emission-intensity calculations in the emission-intensity calculator 2, and the retaining and output of the emission intensity data in the emission-intensity retainer 7.

Reference is made to a period of an n+1^{th} input-image frame. The emission-intensity calculator 2 uses an input image in an n^{th} frame to calculate the emission intensities of the drive areas DA belonging to the calculation group A (CGA). For the drive areas DA belonging to the calculation group A (CGA), the emission-intensity retainer 7 outputs the emission intensity data calculated anew using the input-image in the n^{th} frame. For the drive areas DA belonging to the calculation group B (CGB), the emission-intensity retainer 7 outputs the emission intensity data calculated in the past using an input image in an n−3^{th} frame and retained. For the drive areas DA belonging to the calculation group C (CGC), the emission-intensity retainer 7 outputs the emission intensity data calculated in the past using an input image in an n−2^{th} frame and retained. For the drive areas DA belonging to the calculation group D (CGD), the emission-intensity retainer 7 outputs the emission intensity data calculated in the past using an input image in an n−1^{th} frame and retained.

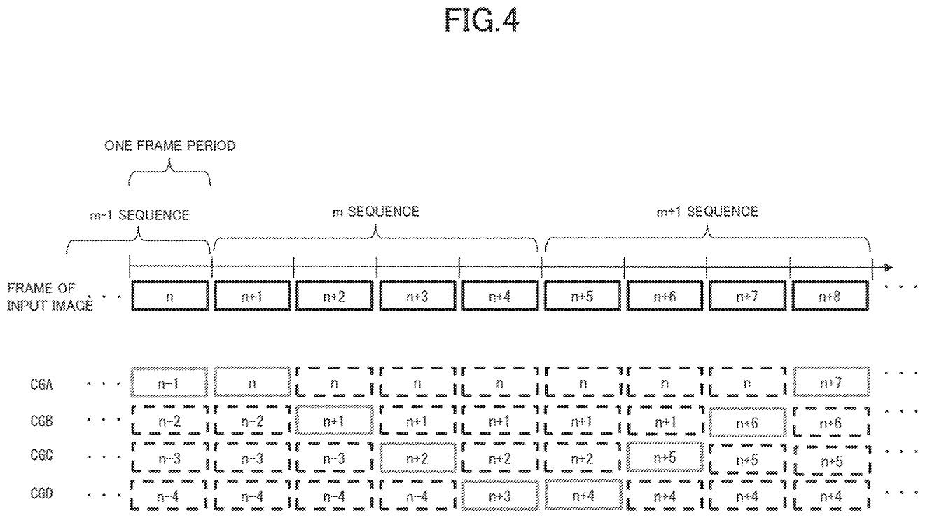

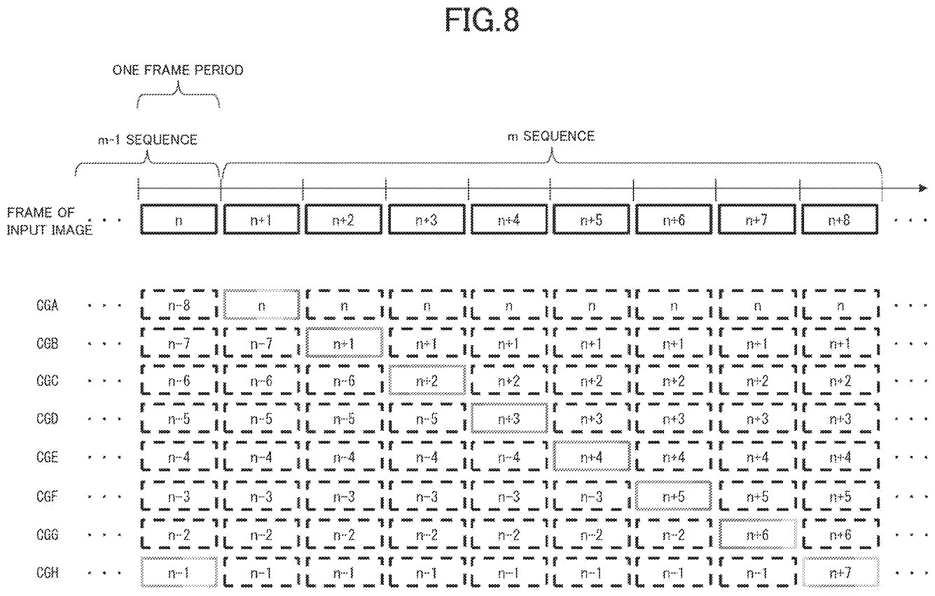

In FIG. 2(b), calculation groups in which the emission-intensity retainer 7 outputs the emission intensities calculated anew in the n+1^{th} frame period are denoted by solid lines, and calculation groups in which the emission-intensity retainer 7 outputs the emission intensities calculated in the past and retained are denoted by broken lines. This holds true for the other frame periods. In addition, since the period for the input image in the n+1^{th} frame is in the middle of input of the image in the n+1^{th} frame, the emission-intensity calculator 2 calculates the emission intensities using the input image in the immediately preceding n^{th} frame. This holds true for the other frame periods. Furthermore, the foregoing descriptions hold true for FIGS. 4 and 8, described later on.

FIG. 2(b) illustrates that in an m sequence for instance, the emission-intensity calculator 2 calculates the emission intensities of the 18 drive areas DA in the upper-left part, belonging to the calculation group A (CGA), on the basis of input image data in an n frame, calculates the emission intensities of the 18 drive areas DA in the upper-right part, belonging to the calculation group B (CGB), on the basis of input image data in an n+1 frame, calculates the emission intensities of the 18 drive areas DA in the lower-left part, belonging to the calculation group C (CGC), on the basis of input image data in an n+2 frame, and calculates the emission intensities of the 18 drive areas DA in the lower-right part, belonging to the calculation group D (CGD), on the basis of input image data in an n+3 frame. That is, the emission-intensity calculator 2 is designed to calculate, in each frame period sequentially, the emission intensities of the drive areas DA belonging to one of the four calculation groups A (CGA) to D (CGD), and to calculate the emission intensities of all the drive areas DA every four frame periods. In other words, the emission-intensity calculator 2 calculates, in each frame period, the emission intensities of the drive areas DA belonging to one of the different calculation groups.

FIG. 2(b) illustrates that the order in which the emission-intensity calculator 2 calculates the emission intensities of the drive areas DA belonging to each calculation group is the same between the m sequence and an m+1 sequence.

FIG. 2(b) illustrates that the emission-intensity calculator 2 performs calculation in the m+1 sequence, which is a sequence immediately after the m sequence, in the same order as the m sequence; That is, the emission-intensity calculator 2 calculates the emission intensities of the 18 drive areas DA in the upper-left part, belonging to the calculation group A (CGA), on the basis of input image data in an n+4 frame, calculates the emission intensities of the 18 drive areas DA in the upper-right part, belonging to the calculation group B (CGB), on the basis of input image data in an n+5 frame, calculates the emission intensities of the 18 drive areas DA in the lower-left part, belonging to the calculation group C (CGC), on the basis of input image data in an n+6 frame, and calculates the emission intensities of the 18 drive areas DA in the lower-right part, belonging to the calculation group D (CGD), on the basis of input image data in an n+7 frame.

Herein, an m−1 sequence is immediately preceding the m sequence, and the m+1 sequence is immediately after the m sequence. Further, the n frame means a frame immediately preceding the n+1 frame, and the n+2 frame means a frame immediately after the n+1 frame.

As described above, the area-active drive unit 1 of the display device 10, which performs emission-intensity calculation on the individual drive areas DA by four-time division, can reduce the volume of emission-intensity calculation of the drive areas DA in each frame period by one quarter less than an instance where the drive areas DA are not driven by time division.

Modification of First Embodiment

FIG. 4 illustrates another example where the emission-intensity calculator 2, included in the area-active drive unit 1 of the display device 10, calculates the emission intensity of each drive area in one of the different calculation groups in each frame period.

FIG. 4 illustrates that in the m sequence for instance, the emission-intensity calculator 2 calculates the emission intensities of the 18 drive areas DA in the upper-left part, belonging to the calculation group A (CGA), on the basis of the input image data in the n frame, calculates the emission intensities of the 18 drive areas DA in the upper-right part, belonging to the calculation group B (CGB), on the basis of the input image data in the n+1 frame, calculates the emission intensities of the 18 drive areas DA in the lower-left part, belonging to the calculation group C (CGC), on the basis of the input image data in the n+2 frame, and calculates the emission intensities of the 18 drive areas DA in the lower-right part, belonging to the calculation group D (CGD), on the basis of the input image data in the n+3 frame.

The emission-intensity calculator 2 may perform calculation in the m+1 sequence, which is immediately after the m sequence, in an order that is reverse from that in the m sequence; That is, the emission-intensity calculator 2 may calculate the emission intensities of the 18 drive areas DA in the lower-right part, belonging to the calculation group D (CGD), on the basis of the input image data in the n+4 frame, calculate the emission intensities of the 18 drive areas DA in the lower-left part, belonging to the calculation group C (CGC), on the basis of the input image data in the n+5 frame, calculate the emission intensities of the 18 drive areas DA in the upper-right part, belonging to the calculation group B (CGB), on the basis of the input image data in the n+6 frame, and calculate the emission intensities of the 18 drive areas DA in the upper-left part, belonging to the calculation group A (CGA), on the basis of the input image data in the n+7 frame.

In other words, the emission-intensity calculator 2 calculates the emission intensities of the drive areas DA belonging to one of the different calculation groups, in each frame period in the m+1 sequence as well.

FIG. 4 illustrates that the order in which the emission-intensity calculator 2 calculates the emission intensities of the drive areas DA belonging to each calculation group is different between the m sequence and the m+1 sequence. In this way, the order of emission-intensity calculation may be changed for each sequence.

For instance, referring to the first embodiment, the emission intensities of the drive areas DA belonging to the calculation groups B to D (CGB to CGD) in the period of the n+1^{th} input image frame are data calculated in the past and do not completely conform to the content of the current input image. This can cause an artifact to be displayed. In the first embodiment, the emission intensities are calculated in the same order for each sequence, thus possibly causing such artifacts in the same order.

In the modification of the first embodiment by contrast, the order of emission-intensity calculation is changed for each sequence, thus changing the order of artifact occurrence, as a result of which artifacts occur randomly. This can provide inconspicuous artifacts. In this case, the area-active drive unit 1 of the display device 10, which performs emission-intensity calculation on the individual drive areas DA by four-time division, can reduce the volume of emission-intensity calculation of the drive areas DA in each frame period by one quarter less than an instance where the drive areas DA are not driven by time division.

### Second Embodiment

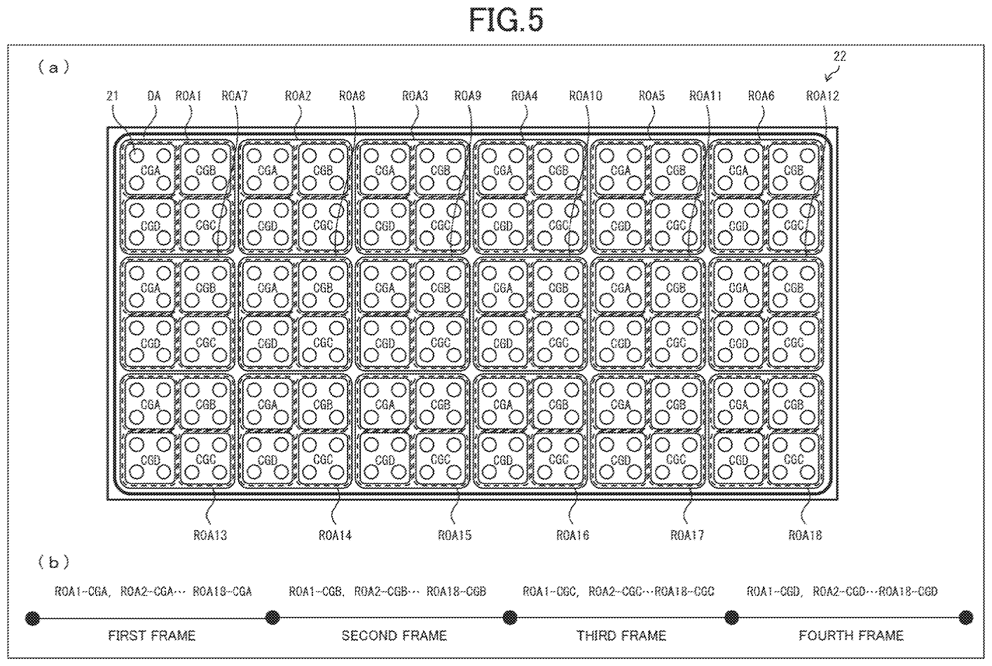

With reference to FIGS. 5 to 8, the following describes a second embodiment of the present disclosure. Backlights 22, 23, and 24 included in a display device according to this embodiment are different from that in the first embodiment in that drive areas DA belonging to the same calculation group are placed in a distributed manner. The other configuration is the same as that described in the first embodiment. For convenience in description, components having the same functions as those illustrated in the drawings relating to the first embodiment will be denoted by the same signs and will not be elaborated upon.

FIG. 5(a) schematically illustrates the configuration of the backlight 22 of the display device according to the second embodiment. FIG. 5(b) illustrates an example where an emission-intensity calculator, included in an area-active drive unit of the display device according to the second embodiment, calculates the emission intensities of drive areas in one of different calculation groups in each frame period. The configuration of the display device according to the second embodiment is similar to the configuration of the display device in FIG. 3 according to the first embodiment with a couple of exceptions, and will not be thus elaborated upon. One of the exceptions is that the backlight 22 is provided, and the other exception is that the area-active drive unit 1 is driven in conformance with the backlight 22.

The backlight 22 includes 24×12 light-emitting elements 21, as illustrated in FIG. 5(a). The backlight 22 is divided into a plurality of drive areas DA (in this embodiment, 72 drive areas DA), each of which individually undergoes area-active drive. Any number of light-emitting elements 21 and any number of drive areas DA may be provided. This holds true for the other embodiments.

Furthermore, 18 drive areas DA belong to a calculation group A (CGA); 18 drive areas DA, to a calculation group B (CGB); 18 drive areas DA, to a calculation group C (CGC); and 18 drive areas DA, to a calculation group D (CGD). That is, the backlight 22 has four calculation groups. Unlike those in the first embodiment, the drive areas DA belonging to each calculation group are placed in a distributed manner. To illustrate this placement, FIG. 5(a) shows the names of the calculation groups to which the individual drive areas DA belong. Herein, each of the calculation groups A (CGA) to D (CGD) is a group that includes the drive areas DA whose emission intensities are calculated simultaneously in one frame period.

The backlight 22 is divided into 18 rotation areas ROA1 to ROA18. Each rotation area includes a single drive area DA belonging to the calculation group A (CGA), a single drive area DA belonging to the calculation group B (CGB), a single drive area DA belonging to the calculation group C (CGC), and a single drive area DA belonging to the calculation group D (CGD). That is, each rotation area includes the same number of drive areas DA (in this case, a single drive area DA) belonging to each calculation group.

As such, the backlight 22 is configured such that a certain drive area DA belongs to any of the calculation groups and is also included in any of the rotation areas.

At least one of the rotation areas needs to include two or more drive areas DA. The two or more drive areas DA need to belong to two or more different calculation groups among the calculation groups. All the rotation areas in the backlight 22 include four drive areas DA. The four drive areas DA belong to the four different calculation groups CGA to CGD. In such a configuration, the drive areas DA belonging to a certain calculation group in the backlight 22 are placed in a distributed manner. In addition, the drive areas DA belonging to a certain calculation group in the backlight 22 are not adjacent to each other.

The drive areas DA included in a certain rotation area by contrast are adjacent to each other. That is, each rotation area is a single continuous area.

Each of the rotation areas ROA1 to ROA18 in the backlight 22 includes one or more calculation groups including at least one identical calculation group. In the backlight 22, each of the rotation areas ROA1 to ROA18 includes four calculation groups, that is, the calculation groups A (CGA) to D (CGD), including four identical calculation groups, that is, the calculation groups A (CGA) to D (CGD).

In the backlight 22, the rotation areas ROA1 to ROA18 have the same shape, and each of the rotation areas ROA1 to ROA18 includes a single drive area DA belonging to each of four calculation groups, that is, calculation groups A (CGA) to D (CGD).

FIG. 5(b) shows a first frame, where the emission intensity of the drive area DA belonging to the calculation group A (CGA) is calculated in each of the rotation areas ROA1 to ROA18. Also shown is a second frame, where the emission intensity of the drive area DA belonging to the calculation group B (CGB) is calculated in each of the rotation areas ROA1 to ROA18. Also shown is a third frame, where the emission intensity of the drive area DA belonging to the calculation group C (CGC) is calculated in each of the rotation areas ROA1 to ROA18. Also shown is a fourth frame, where the emission intensity of the drive area DA belonging to the calculation group D (CGD) is calculated in each of the rotation areas ROA1 to ROA18. That is, the emission-intensity calculator calculates, in each frame period, the emission intensities of the drive areas DA belonging to one of the different calculation groups.

Artifacts can be displayed in the first embodiment, as described above. At this time, the drive areas DA belonging to each calculation group in the first embodiment concentrate in, for instance, the upper-right region of a screen divided into four, as illustrated in FIG. 1. Hence, artifacts can occur in a location in a concentrated manner and can be thus conspicuous.

The backlight 22 in contrast is configured such that the drive areas DA belonging to the same calculation group are placed in a distributed manner. In addition, the drive areas DA belonging to the same calculation group in the backlight 22 are not adjacent to each other. This enables such artifacts as described above, if any, to occur in a distributed manner, thus providing inconspicuous artifacts. In this case, the area-active drive unit, which performs emission-intensity calculation on the individual drive areas DA by four-time division, can reduce the volume of emission-intensity calculation of the drive areas DA in each frame period by one quarter less than an instance where the drive areas DA are not driven by time division.

First Modification of Second Embodiment

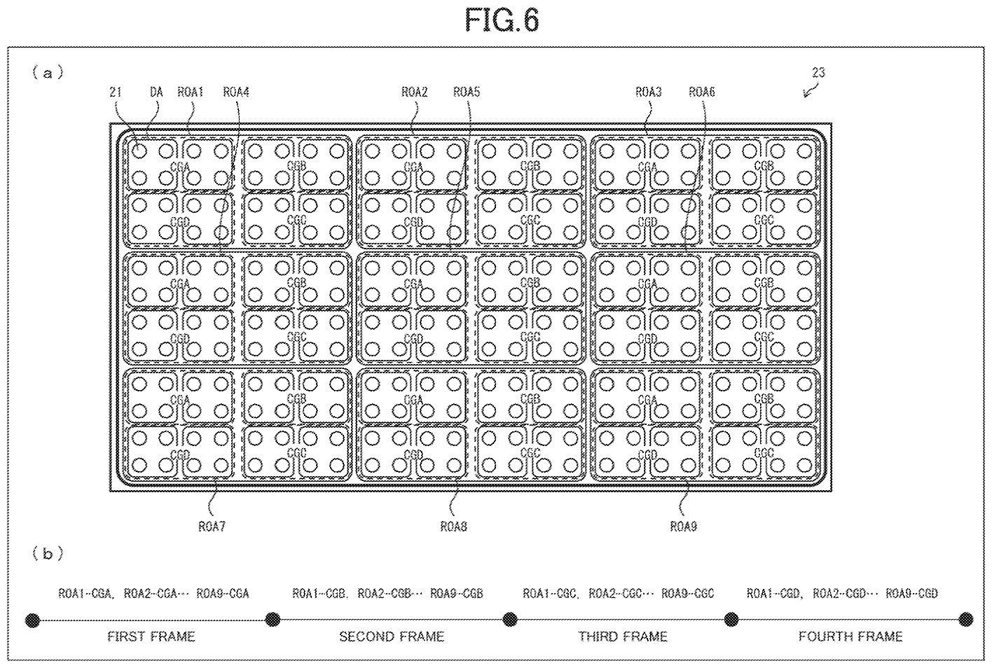

FIG. 6(a) schematically illustrates the configuration of the other backlight 23 included in the display device according to the second embodiment. FIG. 6(b) illustrates an example where the emission-intensity calculator, included in the area-active drive unit of the display device according to the second embodiment, calculates the emission intensities of drive areas in one of different calculation groups in each frame period.

The backlight 23 includes 24×12 light-emitting elements 21, as illustrated in FIG. 6(a). The backlight 23 is divided into a plurality of drive areas DA (in this modification. 72 drive areas DA), each of which individually undergoes area-active drive.

Furthermore, 18 drive areas DA belong to a calculation group A (CGA); 18 drive areas DA, to a calculation group B (CGB); 18 drive areas DA, to a calculation group C (CGC); and 18 drive areas DA, to a calculation group D (CGD). That is, the backlight 23 has four calculation groups. The drive areas DA belonging to each calculation group are placed in a distributed manner in a pair. To illustrate this placement, FIG. 6(a) shows the names of the calculation groups to which every two adjacent drive areas DA belong. Herein, each of the calculation groups A (CGA) to D (CGD) is a group that includes the drive areas DA whose emission intensities are calculated simultaneously in one frame period.

The backlight 23 is divided into nine rotation areas ROA1 to ROA9. Each rotation area includes two drive areas DA belonging to the calculation group A (CGA), two drive areas DA belonging to the calculation group B (CGB), two drive areas DA belonging to the calculation group C (CGC), and two drive areas DA belonging to the calculation group D (CGD). That is, each rotation area includes the same number of drive areas DA (in this case, two drive areas DA) belonging to each calculation group. In each rotation area, the two drive areas DA belonging to each calculation group are adjacent to each other.

As such, the backlight 23 is configured such that a certain drive area DA belongs to any of the calculation groups and is also included in any of the rotation areas.

At least one of the rotation areas needs to include two or more drive areas DA. The two or more drive areas DA need to belong to two or more different calculation groups among the calculation groups. All the rotation areas in the backlight 23 include eight drive areas DA. The eight drive areas DA belong to the four different calculation groups CGA to CGD. In such a configuration, the drive areas DA belonging to a certain calculation group in the backlight 23 are placed in a distributed manner. In addition, the drive areas DA belonging to a certain calculation group in the backlight 23 belong to each rotation area in a pair, and such pairs are not adjacent to each other.

The drive areas DA included in a certain rotation area by contrast are adjacent to each other. That is, each rotation area is a single continuous area.

FIG. 6(b) shows a first frame, where the emission intensities of the drive areas DA belonging to the calculation group A (CGA) are calculated in each of the rotation areas ROA1 to ROA9. Also shown is a second frame, where the emission intensities of the drive areas DA belonging to the calculation group B (CGB) are calculated in each of the rotation areas ROA1 to ROA9. Also shown is a third frame, where the emission intensities of the drive areas DA belonging to the calculation group C (CGC) are calculated in each of the rotation areas ROA1 to ROA9. Also shown is a fourth frame, where the emission intensities of the drive areas DA belonging to the calculation group D (CGD) are calculated in each of the rotation areas ROA1 to ROA9. That is, the emission-intensity calculator calculates, in each frame period, the emission intensities of the drive areas DA belonging to one of the different calculation groups.

As described above, the backlight 23 is configured such that the drive areas DA belonging to the same calculation group are placed in a distributed manner. In addition, the drive areas DA belonging to the same calculation group in the backlight 23 belong to each rotation area in a pair, and such pairs are not adjacent to each other. This enables such artifacts as described above, if any, to occur in a distributed manner, thus providing inconspicuous artifacts. In this case, the area-active drive unit, which performs emission-intensity calculation on the individual drive areas DA by four-time division, can reduce the volume of emission-intensity calculation of the drive areas DA in each frame period by one quarter less than an instance where the drive areas DA are not driven by time division.

Second Modification of Second Embodiment

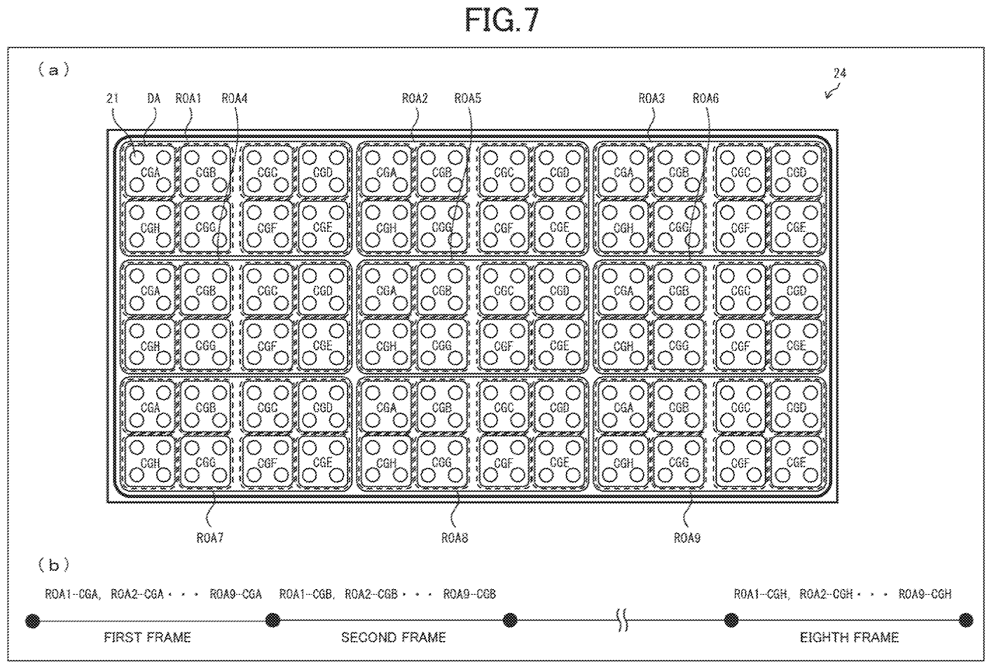

FIG. 7(a) schematically illustrates the configuration of the further other backlight 24 included in the display device according to the second embodiment. FIG. 7(b) illustrates an example where the emission-intensity calculator, included in the area-active drive unit of the display device according to the second embodiment, calculates the emission intensities of drive areas in one of different calculation groups in each frame period.

The backlight 24 includes 24×12 light-emitting elements 21, as illustrated in FIG. 7(a). The backlight 24 is divided into a plurality of drive areas DA (in this modification, 72 drive areas DA), each of which individually undergoes area-active drive.

Furthermore, nine drive areas DA belong to a calculation group A (CGA); nine drive areas DA, to a calculation group B (CGB); nine drive areas DA, to a calculation group C (CGC); nine drive areas DA, to a calculation group D (CGD); nine drive areas DA, to a calculation group E (CGE); nine drive areas DA, to a calculation group F (CGF); nine drive areas DA, to calculation a group G (CGG); and nine drive areas DA, to a calculation group H (CGH). That is, the backlight 24 has eight calculation groups. The drive areas DA belonging to each calculation group are placed in a distributed manner. To illustrate this placement, FIG. 7(a) shows the names of the calculation groups to which the individual drive areas DA belong. Herein, each of the calculation groups A (CGA) to H (CGH) is a group that includes the drive areas DA whose emission intensities are calculated simultaneously in one frame period.

The backlight 24 is divided into nine rotation areas ROA to ROA9. Each rotation area includes a single drive area DA belonging to the calculation group A (CGA), a single drive area DA belonging to the calculation group B (CGB), a single drive area DA belonging to the calculation group C (CGC), a single drive area DA belonging to the calculation group D (CGD), a single drive area DA belonging to the calculation group E (CGE), a single drive area DA belonging to the calculation group F (CGF), a single drive area DA belonging to the calculation group G (CGG), and a single drive area DA belonging to the calculation group H (CGH). That is, each rotation area includes the same number of drive areas DA (in this case, a single drive area DA) belonging to each calculation group.

As such, the backlight 24 is configured such that a certain drive area DA belongs to any of the calculation groups and is also included in any of the rotation areas.

At least one of the rotation areas needs to include two or more drive areas DA. The two or more drive areas DA need to belong to two or more different calculation groups among the calculation groups. All the rotation areas in the backlight 24 include eight drive areas DA. The eight drive areas DA belong to the eight different calculation groups CGA to CGH. In such a configuration, the drive areas DA belonging to a certain calculation group in the backlight 24 are placed in a distributed manner. In addition, the drive areas DA belonging to a certain calculation group in the backlight 24 are not adjacent to each other.

The drive areas DA included in a certain rotation area by contrast are adjacent to each other. That is, each rotation area is a single continuous area.

FIG. 7(b) shows a first frame, where the emission intensity of the drive area DA belonging to the calculation group A (CGA) is calculated in each of the rotation areas ROA1 to ROA9. Also shown is a second frame, where the emission intensity of the drive area DA belonging to the calculation group B (CGB) is calculated in each of the rotation areas ROA1 to ROA9. Also shown is a third frame, where the emission intensity of the drive area DA belonging to the calculation group C (CGC) is calculated in each of the rotation areas ROA1 to ROA9. Also shown is a fourth frame, where the emission intensity of the drive area DA belonging to the calculation group D (CGD) is calculated in each of the rotation areas ROA1 to ROA9. Also shown is a fifth frame, where the emission intensity of the drive area DA belonging to the calculation group E (CGE) is calculated in each of the rotation areas ROA1 to ROA9. Also shown is a sixth frame, where the emission intensity of the drive area DA belonging to the calculation group F (CGF) is calculated in each of the rotation areas ROA1 to ROA9. Also shown is a seventh frame, where the emission intensity of the drive area DA belonging to the calculation group G (CGG) is calculated in each of the rotation areas ROA1 to ROA9. Also shown is an eighth frame, where the emission intensity of the drive area DA belonging to the calculation group H (CGH) is calculated in each of the rotation areas ROA1 to ROA9. That is, the emission-intensity calculator calculates, in each frame period, the emission intensities of the drive areas DA belonging to one of the different calculation groups.

FIG. 8 illustrates an example of the order in which the emission-intensity calculator, included in the area-active drive unit of the display device shown in FIG. 7 according to a second modification of the second embodiment, calculates the emission intensities of the individual drive areas in one of the different calculation groups in each frame period.

FIG. 8 illustrates that in an m sequence for instance, the emission-intensity calculator calculates the emission intensities of the drive areas DA belonging to the calculation group A (CGA) on the basis of input image data in an n frame, calculates the emission intensities of the drive areas DA belonging to the calculation group B (CGB) on the basis of input image data in an n+1 frame, calculates the emission intensities of the drive areas DA belonging to the calculation group C (CGC) on the basis of input image data in an n+2 frame, and calculates the emission intensities of the drive areas DA belonging to the calculation group D (CGD) on the basis of input image data in an n+3 frame. The emission-intensity calculator then calculates the emission intensities of the drive areas DA belonging to the calculation group E (CGE) on the basis of input image data in an n+4 frame, calculates the emission intensities of the drive areas DA belonging to the calculation group F (CGF) on the basis of input image data in an n+5 frame, calculates the emission intensities of the drive areas DA belonging to the calculation group G (CGG) on the basis of input image data in an n+6 frame, and calculates the emission intensities of the drive areas DA belonging to the calculation group H (CGH) on the basis of input image data in an n+7 frame.

As described above, the backlight 24 is configured such that the drive areas DA belonging to the same calculation group are placed in a distributed manner. In addition, the drive areas DA belonging to the same calculation group in the backlight 24 are not adjacent to each other. This enables such artifacts as described above, if any, to occur in a distributed manner, thus providing inconspicuous artifacts. In this case, the area-active drive unit, which performs emission-intensity calculation on the individual drive areas DA by eight-time division, can reduce the volume of emission-intensity calculation of the drive areas DA in each frame period by one eighth less than an instance where the drive areas DA are not driven by time division.

As described above, in this embodiment, the order in which the emission-intensity calculator calculates the emission intensities of the drive areas belonging to each calculation group in the plurality of rotation areas of the same shape is the same between the backlights 22, 23, and 24. In some embodiments, rotation areas may be provided between which this order is different, as described in a third embodiment below.

### Third Embodiment

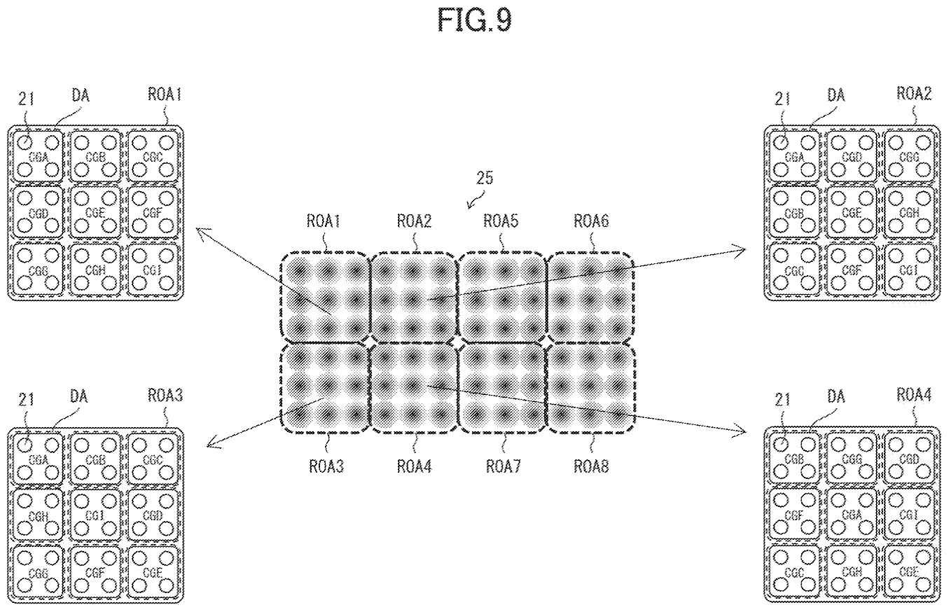

With reference to FIG. 9, the following describes the third embodiment of the present disclosure. In a backlight 25 included in a display device according to this embodiment, some of rotation areas have the same shape; between the rotation areas of the same shape, the order in which an emission-intensity calculator calculates the emission intensities of drive areas belonging to each calculation group is different. In this regard, the backlight 25 is different from those in the second embodiment. The other configuration is the same as that described in the first embodiment. For convenience in description, components having the same functions as those illustrated in the drawings relating to the second embodiment will be denoted by the same signs and will not be elaborated upon.

The backlight 25 is divided into a plurality of drive areas DA (in this embodiment, 72 drive areas DA), each of which individually undergoes area-active drive. Although not the whole is shown in the drawing, each drive area DA includes four light-emitting elements 21.

Although not the whole is shown, eight drive areas DA belong to a calculation group A (CGA); eight drive areas DA, to a calculation group B (CGB); eight drive areas DA, to a calculation group C (CGC); eight drive areas DA, to a calculation group D (CGD); eight drive areas DA, to a calculation group E (CGE); eight drive areas DA, to a calculation group F (CGF); eight drive areas DA, to a calculation group G (CGG); eight drive areas DA, to a calculation group H (CGH); and eight drive areas DA, to a calculation group I (CGI). That is, the backlight 25 has nine calculation groups. The drive areas DA belonging to each calculation group are placed in a distributed manner. To illustrate this placement, FIG. 9 shows the names of the calculation groups to which the individual drive areas DA belong. Herein, each of the calculation groups A (CGA) to I (CGI) is a group that includes the drive areas DA whose emission intensities are calculated simultaneously in one frame period.

The backlight 25 is divided into eight rotation areas ROA1 to ROA8. Each rotation area includes a single drive area DA belonging to the calculation group A (CGA), a single drive area DA belonging to the calculation group B (CGB), a single drive area DA belonging to the calculation group C (CGC), a single drive area DA belonging to the calculation group D (CGD), a single drive area DA belonging to the calculation group E (CGE), a single drive area DA belonging to the calculation group F (CGF), a single drive area DA belonging to the calculation group G (CGG), a single drive area DA belonging to the calculation group H (CGH), and a single drive area DA belonging to the calculation group I (CGI). That is, each rotation area includes the same number of drive areas DA (in this case, a single drive area DA) belonging to each calculation group. FIG. 9 shows the details of only the drive areas DA included in the rotation areas ROA1 to ROA4. The other rotation areas ROA5 to ROA8, the details of which are not shown, are configured similarly.

As such, the backlight 25 is configured such that a certain drive area DA belongs to any of the calculation groups and is also included in any of the rotation areas.

At least one of the rotation areas needs to include two or more drive areas DA. The two or more drive areas DA need to belong to two or more different calculation groups among the calculation groups. All the rotation areas in the backlight 25 include nine drive areas DA. The nine drive areas DA belong to the nine different calculation groups CGA to CGI. In such a configuration, the drive areas DA belonging to a certain calculation group in the backlight 25 are placed in a distributed manner. In addition, the drive areas DA belonging to a certain calculation group in the backlight 25 are not adjacent to each other.

The drive areas DA included in a certain rotation area by contrast are adjacent to each other. That is, each rotation area is a single continuous area.

In each rotation area, the drive area DA belonging to the calculation group A (CGA) undergoes emission-intensity calculation, followed by the drive area DA belonging to the calculation group B(CGB) . . . , followed by the drive area DA belonging to the calculation group I (CGI). That is, the emission-intensity calculator calculates, in each frame period, the emission intensities of the drive areas DA belonging to one of the different calculation groups. In the rotation area ROA1, the emission intensities of the drive areas DA belonging to the respective calculation groups are calculated in the following order: the top row in FIG. 9, from the left to right sides, followed by the middle row in FIG. 9, from the left to right sides, followed by the bottom row in FIG. 9, from the left to right sides. In the rotation areas ROA2, ROA3, and ROA4 by contrast, the order of calculating the emission intensities of the drive areas DA belonging to the respective calculation groups is different from the order in the rotation area ROA1. In the rotation areas ROA5 to ROA8, not shown, the emission intensities of the drive areas DA are calculated in orders different from each other. However, not all the rotation areas need to undergo emission-intensity calculation of their drive areas DA in orders different from each other. At least one of the rotation areas needs to undergo emission-intensity calculation of its drive areas DA in an order different from that in the other rotation areas.

As described above, the backlight 25 is configured such that the drive areas DA belonging to the same calculation group are placed in a distributed manner. Like the backlight 25, different rotation areas can have different placements of the drive areas DA included in the same calculation group, and can have different orders of calculating the emission intensities of the drive areas DA within the rotation areas. This enables such artifacts as described above, if any, to occur in a distributed manner and on a random basis for each rotation area, thus providing inconspicuous artifacts. Artifacts occur randomly when the order of calculating the emission intensities of drive areas belonging to respective calculation groups is different in at least one rotation area. Randomness increases correspondingly when the order of calculating the emission intensities of drive areas belonging to respective calculation groups is different in more rotation areas. In this case, an area-active drive unit, which performs emission-intensity calculation on the individual drive areas DA by nine-time division, can reduce the volume of emission-intensity calculation of the drive areas DA in each frame period by one ninth less than an instance where the drive areas DA are not driven by time division.

### Fourth Embodiment

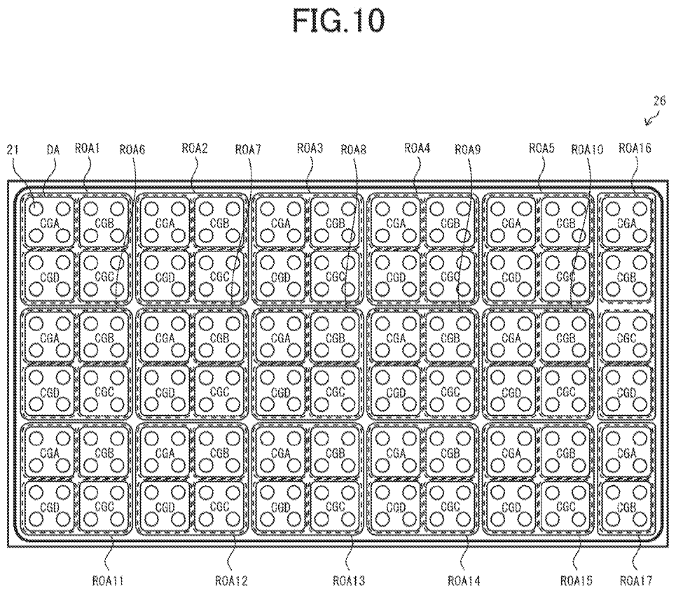

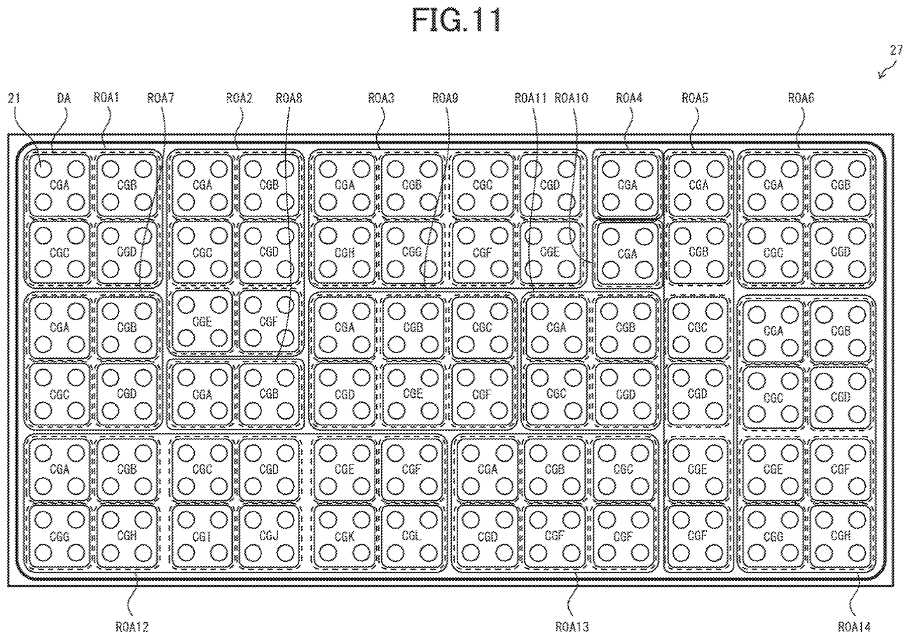

With reference to FIGS. 10 and 11, the following describes a fourth embodiment of the present disclosure. In backlights 26 and 27 included in a display device according to this embodiment, some of a plurality of rotation areas have different shapes. In this regard, the backlights 26 and 27 are different from those in the second and third embodiments. The other configuration is the same as that described in the second and third embodiments. For convenience in description, components having the same functions as those illustrated in the drawings relating to the second and third embodiments will be denoted by the same signs and will not be elaborated upon.

FIG. 10 schematically illustrates the configuration of the backlight 26 included in the display device according to the fourth embodiment. The configuration of the display device according to the fourth embodiment is similar to the configuration of the display device in FIG. 3 according to the first embodiment with a couple of exceptions, and will not be thus elaborated upon. One of the exceptions is that the backlight 26 is provided, and the other exception is that the area-active drive unit 1 is driven in conformance with the backlight 26.

The backlight 26 includes 22×12 light-emitting elements 21, as illustrated in FIG. 10. The backlight 26 is divided into a plurality of drive areas DA (in this embodiment, 66 drive areas DA), each of which individually undergoes area-active drive.

Furthermore, 16 drive areas DA belong to a calculation group A (CGA); 16 drive areas DA, to a calculation group B (CGB); 15 drive areas DA, to a calculation group C (CGC); and 15 drive areas DA, to a calculation group D (CGD). That is, the backlight 26 has four calculation groups. The drive areas DA belonging to each calculation group are placed in a distributed manner. To illustrate this placement, FIG. 10 shows the names of the calculation groups to which the individual drive areas DA belong. Herein, each of the calculation groups A (CGA) to D (CGD) is a group that includes the drive areas DA whose emission intensities are calculated simultaneously in one frame period.

The backlight 26 is divided into 17 rotation areas ROA1 to ROA17. Among the rotation areas ROA1 to ROA17, the rotation areas ROA16 and ROA17 are different from the others in shape and in the number of included drive areas DA.

Each of the rotation areas ROA1 to ROA15 includes a single drive area DA belonging to the calculation group A (CGA), a single drive area DA belonging to the calculation group B (CGB), a single drive area DA belonging to the calculation group C (CGC), and a single drive area DA belonging to the calculation group D (CGD). That is, each of these rotation areas includes the same number of drive areas DA (in this case, a single drive area DA) belonging to each calculation group. Each of the rotation areas ROA1 to ROA15 has a square shape.

Like the rotation areas ROA1 to ROA15, the rotation area ROA16 includes a single drive area DA belonging to the calculation group A (CGA), a single drive area DA belonging to the calculation group B (CGB), a single drive area DA belonging to the calculation group C (CGC), and a single drive area DA belonging to the calculation group D (CGD). The rotation area ROA16 has a shape elongating in the up-and-down direction of the drawing.

The rotation area ROA17 includes only two drive areas DA: a single drive area DA belonging to the calculation group A (CGA), and a single drive area DA belonging to the calculation group B (CGB). The rotation area ROA17 thus has a shape different from the shape of each of the rotation areas ROA1 to ROA16.

As such, the backlight 26 is configured such that a certain drive area DA belongs to any of the calculation groups and is also included in any of the rotation areas.

At least one of the rotation areas needs to include two or more drive areas DA. The two or more drive areas DA need to belong to two or more different calculation groups among the calculation groups. The rotation areas ROA1 to ROA16 in the backlight 26 include four drive areas DA. The four drive areas DA belong to the four different calculation groups CGA to CGD. Moreover, the rotation area ROA17 includes two drive areas DA. The two drive areas DA belong to the two different calculation groups CGA and CGB. In such a configuration, the drive areas DA belonging to a certain calculation group in the backlight 26 are placed in a distributed manner. In addition, the drive areas DA belonging to a certain calculation group in the backlight 26 are not adjacent to each other.

The drive areas DA included in a certain rotation area by contrast are adjacent to each other. That is, each rotation area is a single continuous area.

In each rotation area, the drive area DA belonging to the calculation group A (CGA) undergoes emission-intensity calculation, followed by the drive area DA belonging to the calculation group B(CGB) . . . , followed by the drive area DA belonging to the calculation group D (CGD). That is, an emission-intensity calculator calculates, in each frame period, the emission intensities of the drive areas DA belonging to one of the different calculation groups.

The rotation area ROA17 includes no drive area DA belonging to the calculation group C (CGC) and no drive area DA belonging to the calculation group D (CGD). The rotation area ROA17 thus does not undergo emission-intensity calculation by the emission-intensity calculator, during a frame period for calculating the emission intensities of the drive areas DA belonging to the calculation group C (CGC) and during a frame period for calculating the emission intensities of the drive areas DA belonging to the calculation group D (CGD).

A backlight may be provided that is divided into a plurality of rotation areas including a rotation area of different shape, as described above. For instance, in an effort to divide a backlight into rotation areas including two drive areas DA high by two drive areas DA wide, such a backlight is indivisible in some cases depending on the number of drive areas DA. For instance, although divisible in the longitudinal direction of the screen, the backlight 26 is indivisible in the horizontal direction of the screen. This produces some indivisible drive areas DA at the right end of the screen. The technique of the present disclosure is applicable to even such a backlight provided with differently shaped rotation areas in the indivisible locations. The technique of the present disclosure is also applicable to a display backlight having a shape other than a rectangle, such as a shape with a cut in part of the screen, by changing the shape of a rotation area in the cut location of the backlight.

The drive areas DA belonging to the same calculation group in the backlight 26 are placed in a distributed manner. This enables such artifacts as described above, if any, to occur in a distributed manner, thus providing inconspicuous artifacts. In this case, the area-active drive unit, which performs emission-intensity calculation on the individual drive areas DA by four-time division, can reduce the volume of emission-intensity calculation of the drive areas DA in each frame period by one quarter less than an instance where the drive areas DA are not driven by time division.

Modification of Fourth Embodiment

FIG. 11 schematically illustrates the configuration of the other backlight 27 included in the display device according to the fourth embodiment.

The backlight 27 includes 24×12 light-emitting elements 21, as illustrated in FIG. 11. The backlight 27 is divided into a plurality of drive areas DA (in this modification, 72 drive areas DA), each of which individually undergoes area-active drive.

The backlight 27 has 12 calculation groups: calculation groups A (CGA) to L (CGL). The number of drive areas DA belonging to each calculation group is not the same. The drive areas DA belonging to each calculation group are placed in a distributed manner. To illustrate this placement, FIG. 11 shows the names of the calculation groups to which the individual drive areas DA belong. Herein, each of the calculation groups A (CGA) to L (CGL) is a group that includes the drive areas DA whose emission intensities are calculated simultaneously in one frame period.

The backlight 27 is divided into 14 rotation areas ROA1 to ROA14. Some of the rotation areas ROA1 to ROA14 are different in shape and in the number of included drive areas DA.

For instance, the rotation area ROA12 includes a single drive area DA belonging to each of 12 calculation groups A (CGA) to L (CG L). Each of the rotation areas ROA4 and ROA10 by contrast includes only one drive area DA belonging to the calculation group A (CGA).

Each of the rotation areas ROA2, ROA5, ROA9, and ROA13, for instance, includes six drive areas DA. Herein, the rotation area ROA2 has a shape consisting of three drive areas DA high by two drive areas DA wide. The rotation area ROA5 has a shape consisting of six drive areas DA high by one drive area DA wide. The rotation areas ROA9 and ROA13 each have a shape consisting of two drive areas DA high by three drive areas DA wide. These rotation areas each include a single drive area DA belonging to each of the calculation groups A (CGA) to F (CGF). The other rotation areas each also include several drive areas DA, which belong to any of the calculation groups.

As such, the backlight 27 is configured such that a certain drive area DA belongs to any of the calculation groups and is also included in any of the rotation areas.

At least one of the rotation areas needs to include two or more drive areas DA. The two or more drive areas DA need to belong to two or more different calculation groups among the calculation groups. The rotation areas ROA4 to ROA10 in the backlight 27 each include only one drive area DA. The other rotation areas each include two or more drive areas DA, which belong to two or more different calculation groups among the calculation groups. In other words, there may be a rotation area that includes a single drive area DA, among the plurality of rotation areas. In such a configuration, the drive areas DA belonging to a certain calculation group in the backlight 27 are placed in a distributed manner.

The drive areas DA included in a certain rotation area by contrast are adjacent to each other. That is, each rotation area is a single continuous area. It is noted that although each including only one drive area DA, the rotation areas ROA4 and ROA10 are each a single area; in this regard, the rotation areas ROA4 and ROA10 are similar to the other rotation areas.

In each rotation area, the drive area DA belonging to the calculation group A (CGA) undergoes emission-intensity calculation, followed by the drive area DA belonging to the calculation group B(CGB) . . . , followed by the drive area DA belonging to the calculation group L (CGL). That is, the emission-intensity calculator calculates, in each frame period, the emission intensities of the drive areas DA belonging to one of the different calculation groups.

It is noted that each of the rotation areas ROA4 and ROA10, for instance, includes no drive areas DA belonging to the calculation groups B (CGB) to L (CGL). The rotation areas ROA4 and ROA10 thus do not undergo emission-intensity calculation by the emission-intensity calculator, during frame periods for calculating the emission intensities of the drive areas DA belonging to the calculation groups B (CGB) to L (CGL). The other rotation areas, when including no drive area DA belonging to a certain calculation group, also do not undergo emission-intensity calculation by the emission-intensity calculator, during a period for calculating the emission intensities of the drive areas DA belonging to the certain calculation group.

A backlight may be provided that is divided into a plurality of rotation areas including a rotation area of different shape, as described above. Accordingly, the technique of the present disclosure is also applicable to a case where dividing a backlight into rotation areas having a single kind of shape is impossible, like the backlight 26. Furthermore, such a configuration enhances flexibility in dividing a backlight into a plurality of rotation areas.

The drive areas DA belonging to the same calculation group in the backlight 27 are placed in a distributed manner. This enables such artifacts as described above, if any, to occur in a distributed manner, thus providing inconspicuous artifacts. In this case, the area-active drive unit, which performs emission-intensity calculation on the individual drive areas DA by 12-time division, can reduce the volume of emission-intensity calculation of the drive areas DA in each frame period by one twelfth less than an instance where the drive areas DA are not driven by time division.

### Fifth Embodiment

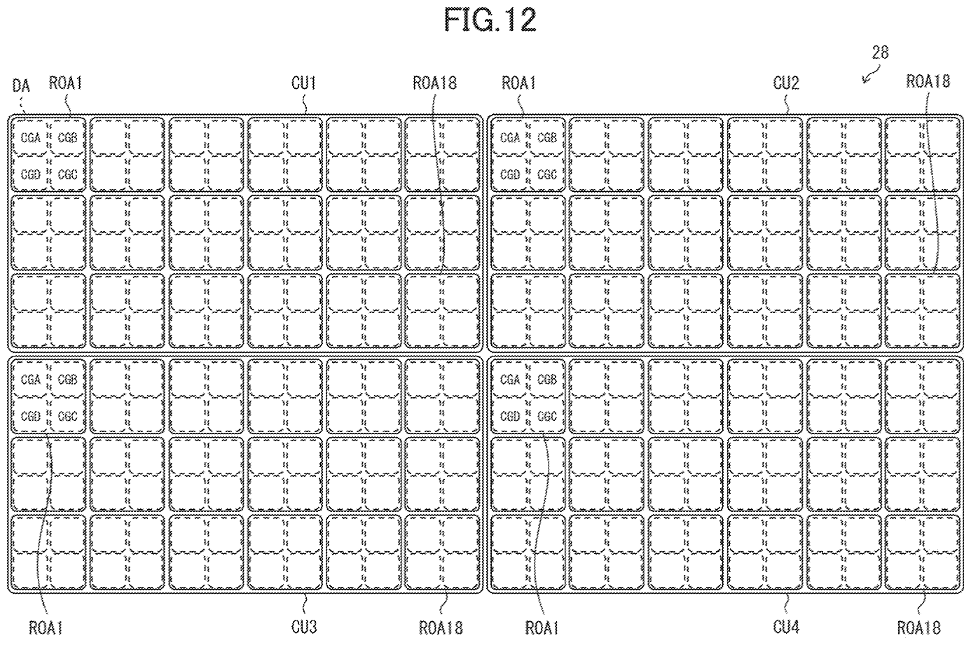

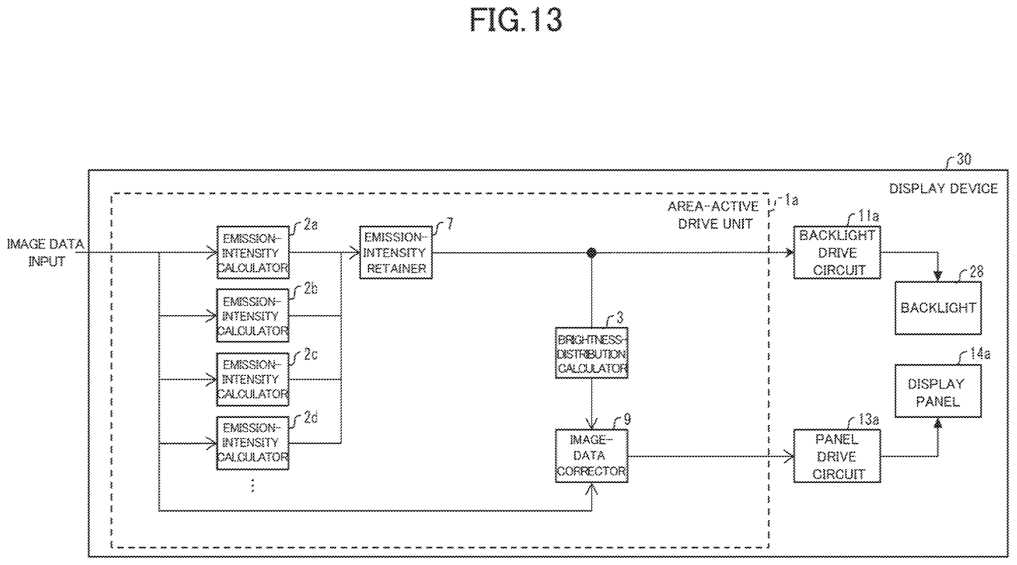

With reference to FIGS. 12 and 13, the following describes a fifth embodiment of the present disclosure. A backlight 28 included in a display device 30 according to this embodiment is divided into a plurality of units of calculation CU1 to CU4; in addition, each of the units of calculation CU1 to CU4 includes two or more calculation groups; in addition, an area-active drive unit 1a includes emission-intensity calculators 2a to 2d respectively provided for the units of calculation CU1 to CU4. In this regard, the display device 30 is different from those according to the second to fourth embodiments. The other configuration is the same as those described in the second to fourth embodiments. For convenience in description, components having the same functions as those illustrated in the drawings relating to the second to fourth embodiments will be denoted by the same signs and will not be elaborated upon.

FIG. 12 schematically illustrates the configuration of the backlight 28 included in the display device 30 according to the fifth embodiment.

The backlight 28 is divided into a plurality of units of calculation (in this embodiment, the four units of calculation CU1 to CU4), as illustrated in the drawing. Each of the units of calculation CU1 to CU4 is divided into 72 drive areas DA, each of which individually undergoes area-active drive. Although not shown, each drive area DA includes 2×2 light-emitting elements 21 adjacent to each other.

Each of the units of calculation CU1 to CU4 of the backlight 28 is divided into a plurality of rotation areas (in this embodiment, 18 rotation areas ROA1 to ROA18).

In this embodiment, each of the rotation areas ROA1 to ROA18 included in the unit of calculation CU1 includes a single drive area DA belonging to a calculation group A (CGA), a single drive area DA belonging to a calculation group B (CGB), a single drive area DA belonging to a calculation group C (CGC), and a single drive area DA belonging to a calculation group D (CGD). Although FIG. 12 illustrates only the four calculation groups in the rotation area ROA1 included in the unit of calculation CU1, each of the rotation areas ROA2 to ROA18 in the unit of calculation CU1 likewise includes a single drive area DA belonging to the calculation group A (CGA), a single drive area DA belonging to the calculation group B (CGB), a single drive area DA belonging to the calculation group C (CGC), and a single drive area DA belonging to the calculation group D (CGD). This holds true for the units of calculation CU2 to CU4. As described, the backlight 28 has four calculation groups. The drive areas DA belonging to each calculation group are placed in a distributed manner within each of the units of calculation CU1 to CU4. Herein, each of the calculation groups A (CGA) to D (CGD) is a group that includes the drive areas DA whose emission intensities are calculated simultaneously in one frame period.

As such, the backlight 28 is configured such that a certain drive area DA belongs to any of the calculation groups and is also included in any of the rotation areas.

At least one of the rotation areas needs to include two or more drive areas DA. The two or more drive areas DA need to belong to two or more different calculation groups among the calculation groups. All the rotation areas in the backlight 28 include four drive areas DA. The four drive areas DA belong to the four different calculation groups CGA to CGD. In such a configuration, the drive areas DA belonging to a certain calculation group in the backlight 28 are placed in a distributed manner. The backlight 28 is also configured such that the drive areas DA belonging to a certain calculation group are not adjacent to each other.

The drive areas DA included in a certain rotation area by contrast are adjacent to each other. That is, each rotation area is a single continuous area.

FIG. 13 schematically illustrates the configuration of the display device 30. The area-active drive unit (area-active drive circuit) la of the display device 30 includes the emission-intensity calculators (emission-intensity calculating circuits) 2a to 2d respectively provided for the units of calculation CU1 to CU4, as illustrated in the drawing. For instance, the emission-intensity calculator 2a calculates the emission intensities of the drive areas belonging to each calculation group within the unit of calculation CU1. In addition, the emission-intensity calculator 2b calculates the emission intensities of the drive areas belonging to each calculation group within the unit of calculation CU2. In addition, the emission-intensity calculator 2c calculates the emission intensities of the drive areas belonging to each calculation group within the unit of calculation CU3. In addition, the emission-intensity calculator 2d calculates the emission intensities of the drive areas belonging to each calculation group within the unit of calculation CU4. At this time, based on input image data, the emission-intensity calculators 2a to 2d calculate, in the respective units of calculation CU1 to CU4, the emission intensity of each drive area DA belonging to one of the different calculation groups A (CGA) to D (CGD) in each frame period, which is a cycle of image update in the display panel 14a. That is, the emission-intensity calculators 2a to 2d individually calculate the emission intensities of all the drive areas DA in the respective units of calculation CU1 to CU4, that is, in parallel (in this embodiment, in the four units of calculation in parallel). Each of the emission-intensity calculators 2a to 2d also calculates the emission intensities of all the drive areas DA in a plurality of divided frame periods (in this embodiment, four divided time periods), each of which is a cycle of image update in the display panel 14a.

A backlight drive circuit 11a drives the backlight 28 for each drive area on the basis of the emission intensity data of the drive area. A panel drive circuit 13a drives the display panel 14a.

The resolution of display devices has increased recently. For instance, whereas a conventional mainstream display device has Full-HD resolution (1920×1080 pixels), a recent display device has 4K resolution (e.g., 3940×2160 pixels) or 8K resolution (7860×4320 pixels). Display devices seem to be further developed for higher resolution in the future. The display panel 14a is a display panel of such high resolution for instance. Such a high-resolution display device needs to have an increased number of backlight drive areas that undergo area-active drive. The backlight 28 is an example backlight having an increased number of drive areas. In the display device including the display panel 14a of high resolution and the backlight 28 with many drive areas, the area-active drive unit 1a performs a greatly increased volume of emission-intensity calculation of the individual drive areas. Even in such a case, the foregoing parallel processing and time division enables the emission intensity of each drive area to be calculated.

As described above, the backlight 28 is configured such that the drive areas DA belonging to the same calculation group are placed in a distributed manner. The backlight 28 is also configured such that the drive areas DA belonging to the same calculation group are not adjacent to each other. This enables such artifacts as described above, if any, to occur in a distributed manner, thus providing inconspicuous artifacts. The area-active drive unit 1a of the display device 30 including the backlight 28 and the display panel 14a, which performs emission-intensity calculation on the individual drive areas DA in four units of calculation in parallel and by four-time division, can reduce the volume of emission-intensity calculation of the drive areas DA in each frame period by one sixteenth less than an instance where the drive areas DA are not driven in parallel and by time division.

The display device 30 includes a plurality of emission-intensity calculators. In some embodiments, the emission-intensity retainer 7, the brightness-distribution calculator 3, the image-data corrector 9, the backlight drive circuit 11a, and the panel drive circuit 13a in whole or in part may be provided in plural form.

Example Implementation by Software

Each unit included in the area-active drive units 1 and 1a of the display devices 10 and 30 may be implemented by a logic circuit (hardware) installed in, for instance, an integrated circuit (IC chip), or implemented by software.

For software, the display devices 10 and 30 each include a computer that executes commands of a program, which is software that implements each function. The computer includes, for instance, at least one processor (controller) and at least one computer-readable recording medium storing the program. The processor in the computer reads the program from the recording medium and executes the program, thus achieving the object of the present disclosure. An example of the processor usable is a central processing unit (CPU). An example of the recording medium usable is a non-transitory tangible medium, including a read-only memory (ROM), a tape, a disc, a card, a semiconductor memory, and a programmable logic circuit. The computer may further include a random access memory (RAM) for developing the program. The program may be supplied to the computer via any transmission medium (e.g., a communication network and a broadcast wave) capable of transmitting the program. One aspect of the present disclosure can be implemented in the form of a data signal in which the program is embodied through electronic transmission and that is embedded in a carrier wave.

Additional Remarks

The present disclosure is not limited to the foregoing embodiments. Various modifications can be devised within the scope of the claims. In addition, an embodiment that is obtained in combination, as appropriate, with the technical means disclosed in the individual different embodiments is also included in the technical scope of the present disclosure. Furthermore, combining the technical means disclosed in the individual embodiments can provide a new technical feature.

The emission intensities of the drive areas DA may be calculated in the same order in a plurality of rotation areas, as described with reference to FIGS. 5 to 8. In addition, the emission intensities of the drive areas DA may be calculated in the same order in some rotation areas of the same shape among a plurality of rotation areas, as described with reference to FIG. 10.

In contrast, at least one of a plurality of rotation areas may undergo emission-intensity calculation of its drive areas DA in an order different from that in the other rotation areas, as described with reference to FIG. 9. This is applicable to other embodiments. Herein, some of a plurality of rotation areas can be different from the others in shape, as described with reference to FIGS. 10 and 11; in this case, the order of calculating the emission intensities of the drive areas belonging to each calculation group is inevitably different between the rotation areas different from each other in shape. This is because that calculation in the same order is impossible in such a case. Accordingly, the order of calculating the emission intensities of the drive areas belonging to each calculation group more commonly needs to be different in at least one of rotation areas of the same shape among a plurality of rotation areas.

FIGS. 5, 7, 9, and 10 have illustrated an example where the drive areas DA belonging to a certain calculation group in the backlight are not adjacent to each other. However, not all the drive areas DA belonging to a certain calculation group have to be not adjacent to each other. For instance, when at least one of the drive areas DA belonging to a certain calculation group is not adjacent to the others, such artifacts as described above can occur in a distributed manner accordingly.

FIG. 6 has illustrated an example where each rotation area includes the same number of drive areas DA (in this case, two drive areas DA) belonging to each calculation group. The drawing also have illustrated that in each rotation area, the two drive areas DA belonging to each calculation group are adjacent to each other. In some embodiments, the plurality of drive areas DA belonging to each calculation group, when included in each rotation area, do not have to be adjacent to each other.

The foregoing embodiments and their modifications have described that the light-emitting elements 21 emit white light. Also described is that area-active drive is controlling the emission intensity of white light emitted from the light-emitting elements included in each backlight drive area DA. The present disclosure is not limited to this configuration. For instance, a light-emitting element that emits red light, a light-emitting element that emits green light, and a light-emitting element that emits blue light may be used as the light-emitting elements 21 and controlled independently. To be more specific, the red light-emitting element may undergo area-active drive by using a red component within an input image, the green light-emitting element may undergo area-active drive by using a green component within the input image, and the blue light-emitting element may undergo area-active drive by using a blue component within the input image.

Although the foregoing embodiments and their modifications have described, by way of example, that the display panel 14 is a liquid-crystal panel, the present disclosure is not limited to a liquid-crystal panel. The technique of the present disclosure is applicable also to a display device that includes a panel other than a liquid-crystal panel as long as such a display device includes a backlight capable of undergoing area-active drive. For instance, a display panel that includes pixels formed by micro electromechanical systems (MEMS) can be used. A MEMS is a device with a mechanical component, an actuator and an electronic circuit integrated on, for instance, a single silicon or glass substrate. A panel with pixels formed by a MEMS includes mechanical shutters that serve as pixels on the panel. The mechanical shutters open and close rapidly in response to image signals. This enables the MEMS to regulate the transmittance of light emitted from a backlight and to display an image, like a liquid-crystal panel. Alternatively, a display panel may be used that includes pixels formed through electro-wetting. In electro-wetting, turning on a switch located between an electrode on the inner surface of a thin tube and an external electrode changes the wettability of a liquid on the inner surface of the thin tube, and decreases the contact angle of the liquid with respect to the inner surface of the thin tube, thus causing the liquid to spread. In contrast, turning off the switch changes the wettability of the liquid on the inner surface of the thin tube and sharply increases the contact angle, thus causing the liquid to drain from the thin tube. Like pixels of a liquid-crystal panel, pixels formed though this phenomenon can open and close by turning on and off a switch, thus enabling the transmittance of light emitted from a backlight and enabling an image to be displayed.

### INDUSTRIAL APPLICABILITY

One aspect of the present disclosure is applicable to a display device.

1. A display device comprising:
an area-active drive circuit;
a backlight divided into a plurality of drive areas that undergo area-active drive by the area-active drive circuit; and
a display panel,
wherein the plurality of drive areas belong to any of a plurality of calculation groups, and
the area-active drive circuit includes
an emission-intensity calculating circuit configured to calculate, based on input image data, an emission intensity of each of the plurality of drive areas in each of frame periods, each of the plurality of drive areas belonging to one of the plurality of different calculation groups, each of the frame periods being a cycle of image update in the display panel.

2. The display device according to claim 1, wherein
the backlight is divided into a plurality of rotation areas,
at least one of the plurality of rotation areas includes two or more drive areas among the plurality of drive areas, and
the two or more drive areas belong to two or more different calculation groups among the plurality of calculation groups.

3. The display device according to claim 2, wherein
the plurality of rotation areas comprise rotation areas having identical shapes, and
the rotation areas having the identical shapes each include an identical number of drive areas belonging to each of the plurality of calculation groups, the identical number of the drive areas being included in the plurality of drive areas.

4. The display device according to claim 2, wherein
the plurality of rotation areas comprise rotation areas having identical shapes, and
the rotation areas having the identical shapes each include a single drive area belonging to each of the plurality of calculation groups, the single drive area being included in the plurality of drive areas.

5. The display device according to claim 24, wherein
the plurality of rotation areas comprise rotation areas having identical shapes, and
an order in which the emission-intensity calculating circuit calculates the emission intensity of each of the plurality of drive areas belonging to each of the plurality of calculation groups is identical between the rotation areas having the identical shapes.

6. The display device according to claim 2, wherein
the plurality of rotation areas comprise rotation areas having identical shapes, and
an order in which the emission-intensity calculating circuit calculates the emission intensity of each of the plurality of drive areas belonging to each of the plurality of calculation groups is different in at least one of the rotation areas having the identical shapes.

7. The display device according to claim 24, wherein the plurality of rotation areas have identical shapes.

8. The display device according to claim 2, wherein the plurality of rotation areas include a rotation area having a different shape.

9. The display device according to claim 14, wherein
the plurality of calculation groups comprise an m number of calculation groups, where m is a natural number equal to or greater than two,
an m frame period is defined as one sequence, and
an order in which the emission-intensity calculating circuit calculates the emission intensity of each of the plurality of drive areas belonging to each of the plurality of calculation groups is identical between a sequence and another sequence.

10. The display device according to claim 1, wherein
the plurality of calculation groups comprise an m number of calculation groups, where m is a natural number equal to or greater than two,
an m frame period is defined as one sequence, and
an order in which the emission-intensity calculating circuit calculates the emission intensity of each of the plurality of drive areas belonging to each of the plurality of calculation groups is different between a sequence and another sequence.

11. The display device according to claim 1, wherein
the backlight is divided into a plurality of units of calculation,
each of the plurality of units of calculation includes two or more of the plurality of calculation groups, and
the area-active drive circuit includes the emission-intensity calculating circuit provided for each of the plurality of units of calculation.

12. A display device comprising:
an area-active drive circuit;
a backlight divided into a plurality of drive areas that undergo area-active drive by the area-active drive circuit;
an emission-intensity calculating circuit configured to calculate, based on input image data, an emission intensity of each of the plurality of drive areas; and
a display panel,
wherein the emission-intensity calculating circuit calculates the emission intensities of all the plurality of drive areas in a plurality of divided frame periods, with a cycle of image update in the display panel being defined as one frame period.

13. The display device according to claim 12, wherein the plurality of drive areas whose emission intensities are calculated by the emission-intensity calculating circuit in the one frame period are placed in a distributed manner.

14. The display device according to claim 12, wherein the plurality of drive areas whose emission intensities are calculated by the emission-intensity calculating circuit in the one frame period are not adjacent to each other.

15. The display device according to claim 1, wherein each of the plurality of drive areas includes one or more light-emitting elements.

16. The display device according to claim 12, wherein an m frame period is defined as one sequence, and
an order in which the emission-intensity calculating circuit calculates the emission intensity of the plurality of drive areas is different between a sequence and another sequence.
